(19) United States
(12) Patent Application Publication
(10) Pub. No.: US 2003/0014287 A1
(43) Pub. Date: Jan. 16, 2003

(54) Continuity of supply risk and cost management tool

(75) Inventors: Anna Belle Williams, Austin, TX (US); Cecilia A. Trevino, Austin, TX (US); Frank R. Walker JR., Round Rock, TX (US); Guy A. Schweppe, Cedar Park, TX (US); David W. Bulger, Pflugerville, TX (US); Jonathan B. Safran, Austin, TX (US); Patrick W. Lynch, Austin, TX (US)

Correspondence Address: HAMILTON & TERRILE LLP, P O Box 203518, Austin, TX, 78720, US

(73) Assignee: Dell Products, L.P.

(21) Appl. No.: 09/896,992

(22) Filed: Jul. 2, 2001

(51) Int. Cl. G06F 17/60

(52) U.S. Cl. 705/7

(57) ABSTRACT

Managing risk of a supply chain and creating a bill of materials is disclosed. Identifying materials by geographical location of the source of the material and using an indicia of geopolitical risk with the geographical location to determine a geopolitical risk associated with the material is disclosed. Certain features allow a user to assess capital cycle risk of specific components. Similarly, a user can identify all components in bills of material subject to a specific innovation risk A method to determine a best bill of materials cost based on a benchmark cost is also set forth. The disclosure also describes a system for managing information to purchase material for use in a manufacturing process is also set forth.

### BACKGROUND OF THE INVENTION

1. Field of the Invention

The invention relates to a method for doing business, more specifically to managing risk associated with continuity of supply and ensuring best landed cost.

2. Description of the Related Art

It is known that manufacturers assemble computers and other goods from components supplied by vendors and other suppliers. Suppliers may include other manufacturers which manufacture a component from raw materials or other assemblers which assemble a component from purchased sub-components. In some cases a supplier may be both a manufacturer and assembler. An extensive network of suppliers and assemblers has developed to meet the need of the electronics manufacturing industry.

Manufacturers develop a plan, specification or design from which to assemble a specific product. It is known to incorporate a bill of materials (BOM) in the design. Vendors submit bids to provide components as specified in the bill of materials. Manufactured products in general, and computer systems in particular, are assembled from components obtained from numerous vendors. Each vendor can obtain sub-components from other vendors. A shortage at any step in the chain impacts a manufacturer's production schedule and increases costs to a consumer. What is needed is a method to minimize risk of interruption in supplies to components to manufacture a finished product. Preferably, the solution would allow the manufacturer to identify concentrations of purchases by geography, political climates and specific vendors.

### SUMMARY OF THE INVENTION

The present disclosure describes a method of managing risks when risks can be created by disruptions in material supply to a manufacturing facility. The present invention relates to managing risk of a supply chain. The disclosure teaches a method to create a bill of materials. The disclosure also describes identifying materials by geographical location of the source of the material and using an indicia of geopolitical risk with the geographical location to determine a geopolitical risk associated with the material. An embodiment of the invention also teaches identifying material in the bill of the materials by vendor or assembler to determine supplier concentration.

Similarly, certain features of the invention allow a user to assess capital cycle, innovation, supplier power, and geopolitical risk of specific components. A user can then identify all components in bills of materials having those specific risks. An embodiment of the invention teaches identifying the end-of-life date of materials used to manufacture a product.

The present disclosure also describes a method of forecasting materials requirements. In addition, the disclosure also describes a method to determine a best bill of materials cost based on a benchmark cost of equivalent materials. The disclosure describes a method of designing and assembling a computer system. The disclosure also describes a system for managing information to purchase material for use in a manufacturing process. Included in the disclosure is a method of electronically storing information used in the purchasing process.

The foregoing is a summary and this contains, by necessity, simplifications, generalizations and omissions of detail; consequently, those skilled in the art will appreciate that the summary is illustrative only and is not intended to be in any way limiting.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 shows a logical architecture of the method.

FIG. 2 is an illustrative example of a report available from the data captured by the method showing geopolitical concentration.

FIG. 3 is an illustrative example of a report available from the data captured by the method showing supplier concentration.

FIGS. 4A and 4B are plan views of a presentation showing a user interface with a computer program executing the method.

FIGS. 5A and 5B are plan views of a presentation showing a user interface with a computer program executing the method.

FIGS. 6 is a plan view of a presentation showing a user interface with a computer program executing the method.

FIG. 7 is a plan view of a presentation showing a user interface with a computer program executing the method.

FIGS. 8A, 8B and 8C are illustrative examples of reports available from the data captured by the method.

FIG. 9 is an illustrative example of a report available from the data captured by the method.

FIG. 10 depicts a flow diagram of the continuity of supply methodology.

FIGS. 11A and 11B are illustrative examples of reports available from the Continuity of Supply (COS) Methodology.

FIG. 12 is an example organization hierarchy for semiconductor components.

FIG. 13 is a block diagram of a computer system suitable for implementing embodiments of the present invention.

FIG. 14 is a block diagram illustrating a network environment in which embodiments of the present invention may be practiced.

### DETAILED DESCRIPTION

The present disclosure describes a method for identifying and evaluating risk associated with the continuity of supply of material to a manufacturing or assembly facility. The bill of materials tool (the “BOM tool” or simply “the tool”) allows a user to look across all commodities to determine potential affects of an interruption in the continuity of supply. A Continuity of Supply Methodology allows a user to assess capital cycle, innovation, supplier power or geopolitical risk. As discussed further below, the tool contributes to determining geopolitical and supplier power risk. Innovation and capital cycle risk are determined separately. Additionally, once a particular risk is determined to impact a particular component class, the tool can then be used to identify the commodities containing the at-risk material.

Potential risks to the continuity of supply can be identified by characterizing the materials in a bill of materials. Materials can be characterized by vendor, manufacturer, manufacturer's part number, assembler, country of origin, fabrication foundry name, lead time, etc. Throughout this disclosure a computer system is used as an example, however, the example is not limiting and the method is applicable to other manufactured items.

The disclosure teaches determining a best bill of materials cost for items used by a manufacturer. A best bill of materials cost is determined using a benchmark cost for items on the bill of materials. As discussed further below, determining a cost benchmark involves determining the cost associated with the manufacture, shipping and handling of the item. A feature of the invention teaches determining the cost of operating and maintaining a supplier logistic hub (referred to as an SLC). Utilizing a supplier logistic hub allows a manufacturer to have a quantity of material available on short notice. Utilizing a supplier logistic hub allows a manufacturer to reduce inventory, reduce associated inventory costs and to minimize potential interruptions on the continuity of supply to a manufacturing facility.

The Bill of Materials Tool

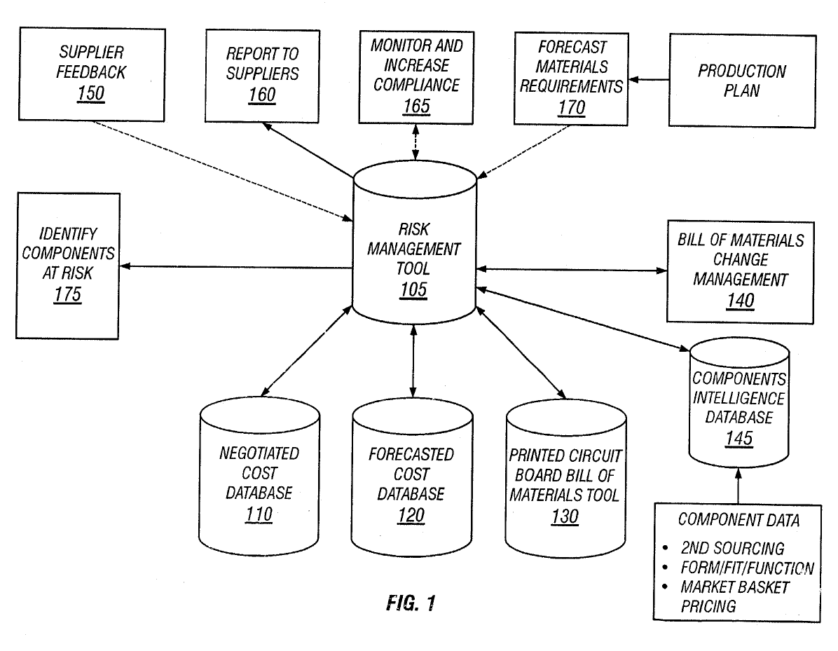

FIG. 1 shows the logical inter-relation between functional components of the method including functions performed by software modules (or databases) and functions performed by human interaction (features) with the software. Specifically, FIG. 1 illustrates the relationship between risk management tool 105 and other modules and features. Negotiated cost module 110 stores negotiated cost information. When a negotiated price is reached with a supplier the agreed price is entered and tracked for future reference. Forecasted cost module 120 is a tool for forecasting costs. Based on the best available data forecasted costs are entered into module 120 and assembled to predict future prices.

In one embodiment, printed circuit board bill of materials module 130 (referred to as “PCBA BOM tool”) organizes and stores data pertaining to printed circuit board assemblies. Specifically, a computer manufacturer may design proprietary circuit boards such as system boards or motherboards. Printed circuit board bill of material module 130 provides a database to compare cost information for printed circuit boards. Data from printed circuit board bill of materials module 130 is imported to risk management tool 105. In a preferred embodiment, printed circuit board module 130 will be incorporated into risk management tool 105.

Module 140 performs bill of material change management. If a supplier, manufacturer or original equipment manufacturer (OEM) initiates a change to a bill of materials, module 140 stores and manages the change. Module 140 automatically manages and tracks the substitution of functionally equivalent components and manages and tracks engineering changes. In a preferred embodiment, module 140 is incorporated into risk management tool 105.

Module 145 (referred to as “Components Intelligence Database”) supports increasing supplier compliance in supporting the tool. Module 145 eliminates data entry errors and inefficiency associated with the bill of materials load process by automatically incorporating component attribute data from a third-party database using the component manufacturer's part numbers. Module 145 also identifies substitute or alternate part numbers having the same form, fit and function as components in the database of risk management tool 105 for the purpose of mitigating risk associated with single and sole-sourced components.

Feature 150 (referred to as “supplier feedback”) provides a supplier the opportunity to provide comments and suggestions during software development. For example, after testing a prototype of risk management tool 105, suppliers can suggest improvements, thus enhancing utility of the tool to the suppliers. Incorporating a supplier's suggestions during software development creates an incentive for the supplier to provide information (bills of material, component part numbers and attributes) to risk management tool 105.

Module 160 (referred to as “report to suppliers”) provides data to a supplier. Providing data to a supplier also enhances the utility of the tool to the supplier, encouraging the supplier to participate in the method by providing bills of material and other information.

Feature 165 (referred to as “monitor and increase compliance”) provides a mechanism to monitor the amount of purchased material included in the tool. Certain components will not be included in the tool for strategic reasons. For example, in the case of a computer system, the central processing unit will not necessarily be included in the tool. Feature 165 allows the manufacturer to identify those materials purchased, but not tracked by the tool. Tracking materials purchased but not included in risk management tool 105 gives a manufacturer a view into which suppliers are non-compliant. Increasing the number of bills of material stored in data processing feature 105 necessitates participation by suppliers.

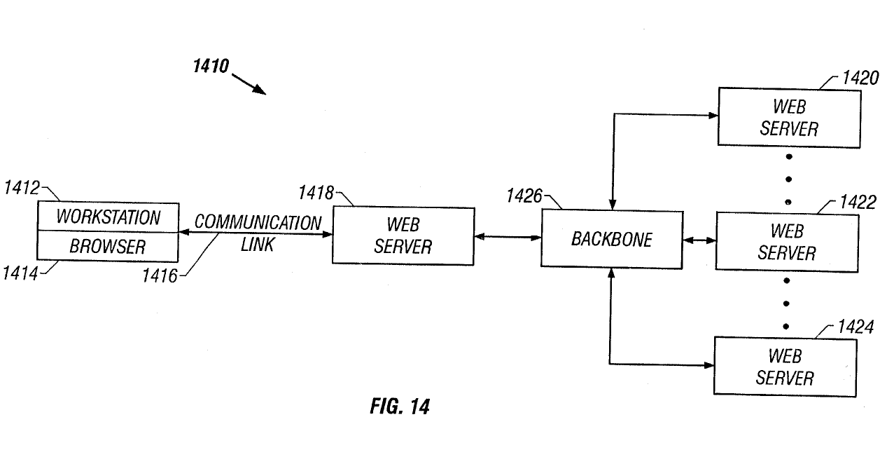

Supplier participation typically includes providing bills of material and other information electronically to the manufacturer. Typically, information is provided over the Internet but the invention is not limited to a specific system. The Internet is a global public communication network that supports various functions including the world wide web and email. But the method is operable on other electronic networks and the example should not be taken to be limiting. However, the Internet, (further described in FIG. 14 below), is used as an example throughout this application.

Feature 170 (referred to as “forecast material requirements”) considers forecasted sales. After considering forecasted sales, feature 170 receives a production plan and generates a materials requirement plan to support the production plan. For example, a production plan would be produced for a specific computer system such as a Dell Optiplex system. The production plan estimates the number of systems to be produced for each model of Optiplex. After developing a production plan, feature 170 considers an attach rate for purchased parts. An attach rate predicts the number of component parts purchased independently that are required to support the production plan. For example, if a production plan predicts that 100,000 Optiplex Model 1 computers will be manufactured in a certain month and if a specific monitor has an attach rate of 65%, then 65,000 monitors will be required in the month identified.

Identifying the quantities of components to be purchased allows the manufacturer to determine the quantities of materials necessary to produce those items. Thus, feature 170 applies the forecast to all purchased parts to develop a comprehensive material requirement plan. Forecasting quantities of purchased materials allows buyers to develop purchase orders and allows suppliers to develop manufacturing plans. If materials are not available in quantities necessary to support the manufacturing plan, manufacturing schedules may be interrupted. Interrupting a manufacturing schedule impacts production facilities and personnel creating a risk to the continuity of supply. Once a component is identified as at-risk, risk management tool 105 allows a manufacturer to determine which purchased parts are affected by the at-risk component. As discussed further below, the method includes steps to develop, implement, monitor and revise strategies to mitigate risks to the continuity of supply.

Risks to the continuity of supply can be divided into four categories: supplier power risk, geopolitical risk, capital cycle risk and innovation risk. As discussed further below risk management tool 105 allows a user to identify the components, bills of material and product lines affected by those risks.

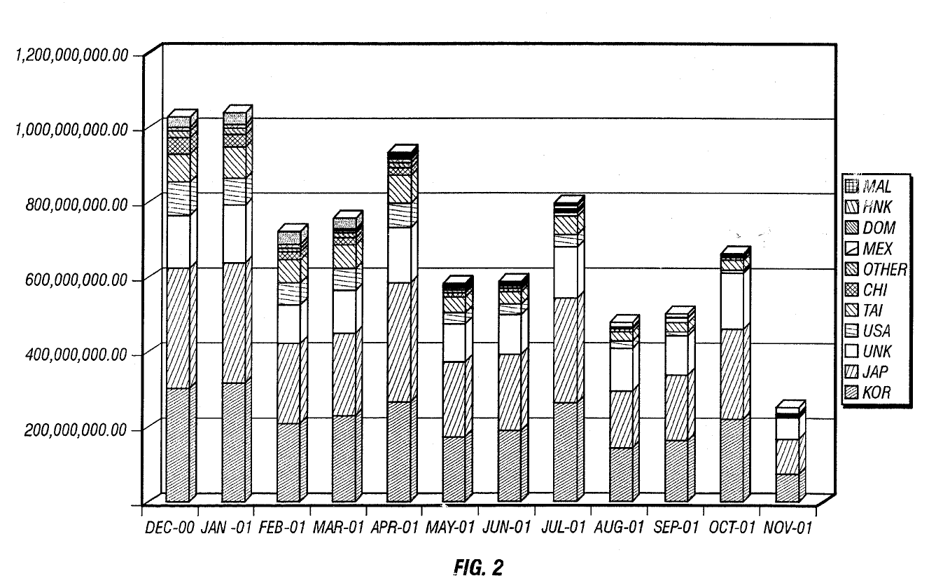

Geopolitical risk is evaluated based on geographic concentration and the risk associated with a location. Risk management tool 105 captures the country of origin of each component. The country of origin of each component is used to determine geographic concentration associated with a particular component. Based on this concentration, the methodology can use a geopolitical risk factor to assess the risk associated with a specific component. A third party publication such as The Country Risk Service published by the Economist Intelligence Unit provides an indicia of geopolitical risk for all countries based on geographic location, economy and political environment. Based on this concentration the methodology can use the geopolitical risk factor to assess the risk associated with a specific component. FIG. 2 shows an example of the geopolitical concentration of a component (in this case, capacitors) as plotted against months of a year.

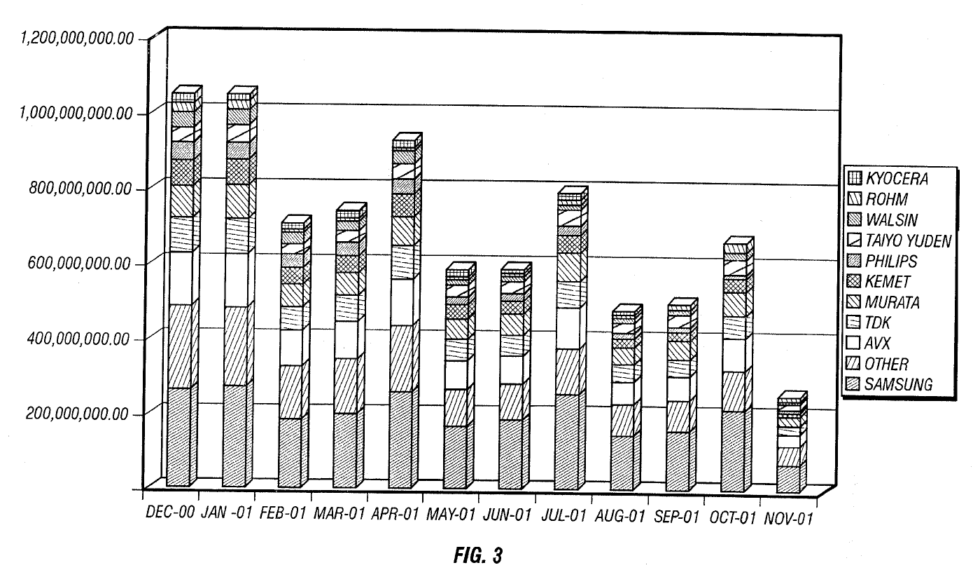

Similarly, the method allows a user to identify a manufacturer's supplier concentration associated with a particular component. In general, fewer suppliers of a component creates a higher risk. For example, one supplier responsible for supplying all of a component may create risk to the continuity of supply. If the supplier's deliveries were interrupted for any reason, the manufacturer's supply chain would be disrupted and the manufacturer would incur expense which may be avoidable, or minimized. The method allows a user to identify supplier concentration associated with a component so that steps can be taken to maintain the continuity of supply. For an example of a graph showing the supplier concentration of capacitors by month, refer to FIG. 3. Again, capacitors are used as an example of a component and the example is not limiting.

Supplier concentration is one variable which contributes to supplier power risk. Another variable dealing with supplier power risk is the manufacturer's ability to influence the supplier. A manufacturer's ability to influence a supplier is based on several variables including two quantitative and one qualitative factor. The first quantitative factor is the percentage of the manufacturer's business the supplier represents. For example, a computer manufacturer's ability to influence a hard drive manufacturer depends on the percentage of hard drives used by the manufacturer provided by the supplier. The second quantitative factor determining a manufacture's ability to influence a supplier is the percentage of output of the supplier the manufacturer represents. In the preceding example, a computer manufacturer has a greater ability to influence a hard drive manufacturer if the manufacturer purchases 100% of the hard drives manufactured by the supplier. Finally, the relationship between the manufacturer and supplier also influences risk due to supplier power. The relationship is measured qualitatively (e.g., poor, fair or good) and can be influenced by the quantitative factors described above.

Module 175 allows a user to determine the risk due to the capital cycle. Capital cycle is determined by the predictability of demand versus supply and capital flexibility. Capital flexibility is based on cost and time to add capacity. For example the capital flexibility to add a semiconductor manufacturing facility is low due to the long lead time (two years or more) and the large capital investment required (in excess of two billion dollars). As further discussed below, capital flexibility is higher if less lead time and less capital investment is required. For example a modification to an existing production line would require less lead time and less capital investment, therefore capital flexibility would be higher. As illustrated further below, when capital spending is low, utilization increases because demand is expanding and capacity is not increasing.

Capital cycle risk is also determined by the predictability of product demand versus supply (demand-supply predictability). Demand-supply predictability is based on the technological life cycle of the product and competition for capacity. Product demand may be characterized by the technology life cycle; introduction, growth, maturity and decline. For example, personal computers are characteristically in the maturity stage of the technology life cycle. Products in the maturity stage are more predictable than products in the introduction and decline stages. Similarly, products in the introductory stage of product life-cycle have the most uncertain demand versus supply relationship.

Risk management tool 105 includes an indicia (e.g., a date) of the projected end-of-life for components listed on the bill of materials. End-of-life is an indication of the date after which a component will no longer be manufactured for any reason including commercial or technical reasons. Identifying end-of-life helps to prevent designing products which include components which are approaching end-of-life. When components are identified with an imminent end-of-life, substitutions can be found for products under design and measures can be taken to mitigate the risk to the continuity of supply of that component. The method identifies all components with a pending end-of-life automatically, at predetermined intervals. For example, ideally the method would identify items nearing end-of-life on a monthly, weekly or daily basis. A desired feature of the method would identify the end-of-life date of each component on every bill of materials.

Risk management tool 105 allows a user to determine all bills of material containing a specific component subject to a specific innovation risk. After identifying a component which may be at-risk due to innovation, risk management tool 105 allows a user to identify all products or product lines incorporating that component. Two major drivers influence innovation risk. The first driver of innovation risk is the length of time required to transition a large percentage of the customer base to a new technology. In certain industries, or in specific areas of an industry, market forces may drive change to a design. A second driver of innovation risk is the number of product offerings containing a component subject to innovation. The larger the number of product offerings containing a component subject to replacement due to innovation the larger the innovation risk. A large number of product offerings combined with a short time to transition a large percentage of the customer base to a new technology creates a high innovation risk. Other factors, such as the lead time required by a supplier to provide a modified or replacement component, also affect innovation risk. As further illustrated below, innovation risk increases the complexity of managing the continuity of supply.

Using a computer system as an example of the product being manufactured, users who purchase a computer system primarily for video gaming can expect a new multimedia standard in a brief period of time. For example, changes to graphics systems in a computer are often driven by enhancements in video display technology which creates market demand. In this example, computer users interested in video gaming necessitate design changes to incorporate an improved video display technology, thus creating an innovation risk. In this example, product offerings intended for purchase by users for video gaming will have a higher innovation risk.

Similarly, risk management tool 105 allows a user to have visibility of components across purchased assemblies. For example, if a resistor is determined in to be at-risk due to geopolitical factors risk management tool 105 allows a user to determine the bills of material including the resistor. Determining the bills of material including the resistor allows the user to determine the products which will be impacted by a shortage of the resistor. Similarly, if a resistor is at-risk due to supplier concentration then risk management tool 105 allows a user to evaluate the impact of the potential shortage to plans to manufacture a certain number of products.

Risk management tool 105 allows a manufacturer to determine which of the manufacturer's products can be affected by a potential shortage. Continuing the preceding example, a computer manufacturer can determine the effect of a potential shortage of memory on the product lines (e.g., computer systems) manufactured. The manufacturer can evaluate a shortage of flash memory of 16 megabits. In this example the manufacturer can determine that only a line of servers includes the flash memory being considered. After quantifying the impact in risk management tool 105, a user can complete the remaining steps of the Continuity of Supply Methodology as further discussed and illustrated below.

Quantifying the impact of a potential shortage may be necessary to mitigate the risk (as described further below). Consider again the example of evaluating the potential impact of a shortage of flash memory. Quantifying the impact of a shortage can include the gross-margin impact. The gross-margin impact determines the impact of the potential shortage on each product line manufactured. For example, in the example previously given a shortage of memory can impact the manufacture of a line of servers. If an interruption in supply requires two weeks to remedy the potential impact is two weeks loss of production of the server. Quantifying the impact of a shortage can include prioritizing the risk.

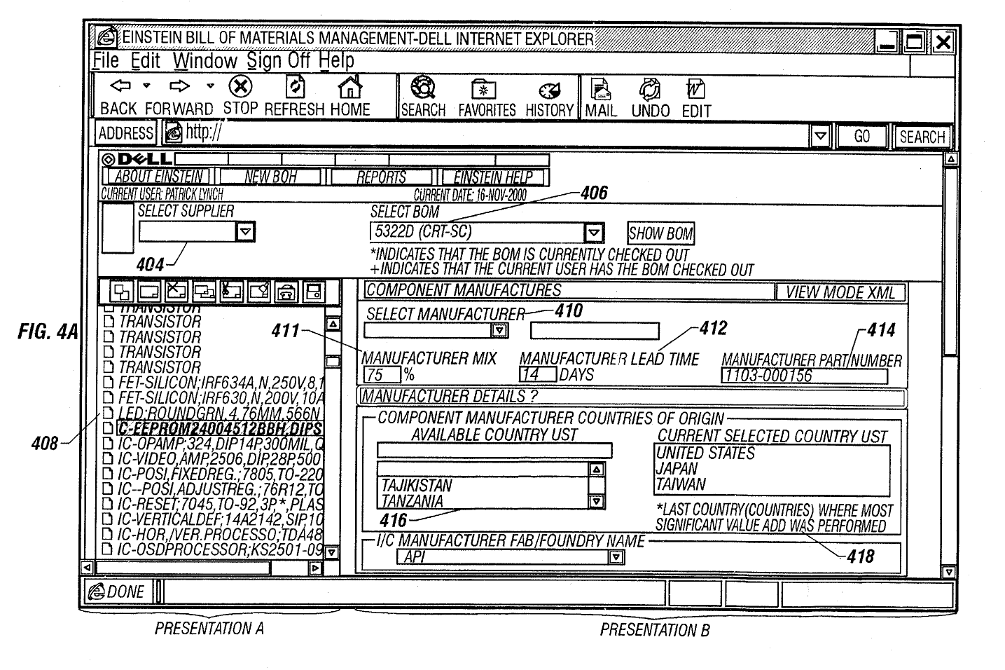

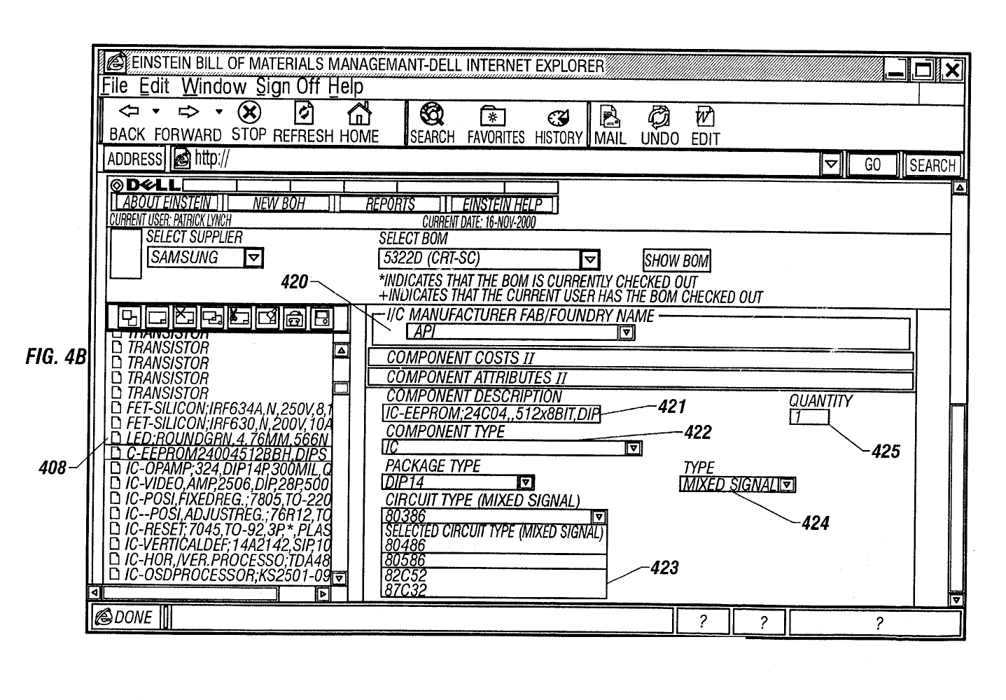

FIGS. 4A and 4B are plan views of a presentation used to illustrate several features of risk management tool 105. The presentation includes drop-down menu 404 which allows a user to identify a specific supplier from a list. If a supplier provides multiple bills of material, drop-down menu 406 allows a user to select a specific bill of materials from the multiple bills of material provided by an individual supplier. The bill of materials identified in drop-down menus 404 and 406 is displayed on the left-hand side of FIGS. 4A and 4B as illustrated in presentation 408. Presentation 408 includes component descriptions. The component descriptions included in the bill of materials identified in presentation 408 are received from the supplier as selected from supplier list in drop-down menu 404. The bill of materials identified in presentation 408 is divided into 3 categories, a root a sub-assembly and a component. A root is the highest level description in a bill of materials. A root may contain sub-assemblies which may be divided further into individual components. A component is not divided further.

For a particular sub-assembly or component there may be multiple suppliers. Component manufacturer-mix portion 411 allows a supplier to specify what percent of sub-assemblies or components are obtained from the list of suppliers for those sub-assemblies or components. Drop-down menu 410 allows a user to identify and select a component manufacturer for the specific component or sub-assembly highlighted in presentation A from a list of component manufacturers. When the user selects a component manufacturer from the list provided in drop-down menu 410, the user specifies the percentage of materials provided by that component manufacturer in component manufacturer-mix portion 411. Similarly, the user may specify the lead time for that sub-assembly or component highlighted in presentation A in component manufacturer lead time portion 412. The percentage of materials and lead time information is then available when the sub-assembly or component is subsequently accessed.

Component manufacturer part number portion 414 allows a user to specify a component manufacturer's part number for a sub-assembly or component. Country of origin portion 418 identifies the country of origin for the component highlighted in presentation A, which is defined as the last country where significant value was added.

Referring now to FIG. 4B, drop-down menu 420 is defined when a component is identified as an integrated circuit. When a component is identified as an integrated circuit, drop down menu 420 provides a list of possible fabrication foundries. Fabrication foundries are sites which manufacturer integrated circuits. The user selects the particular fabrication foundry that manufactures the particular component from the list of possible fabrication foundries.

The bill of materials as identified in menus 404 and 406 is displayed as shown in presentation 408. Selecting an element of a bill of materials displays the attributes of that element on the right hand side of the screen 421, 422, 423, 424 and 425 (Presentation B). Component description portion 421 reflects a description or the element selected. Component type portion 422 displays the type of component, for example a resistor, capacitor or integrated circuit, that applies to the selected element. If a root is selected, then component type 422 shows the root type, for example a disk array. Component type portion 422 also determines the list that the information is selected from in package type portion 422, circuit type portion 423 and type portion 424.

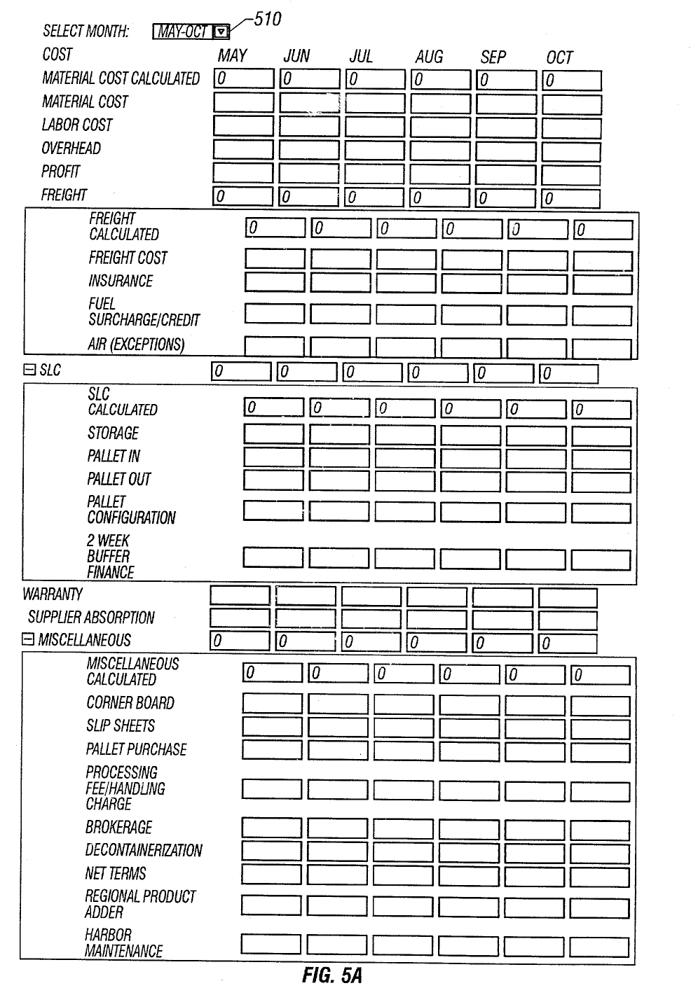

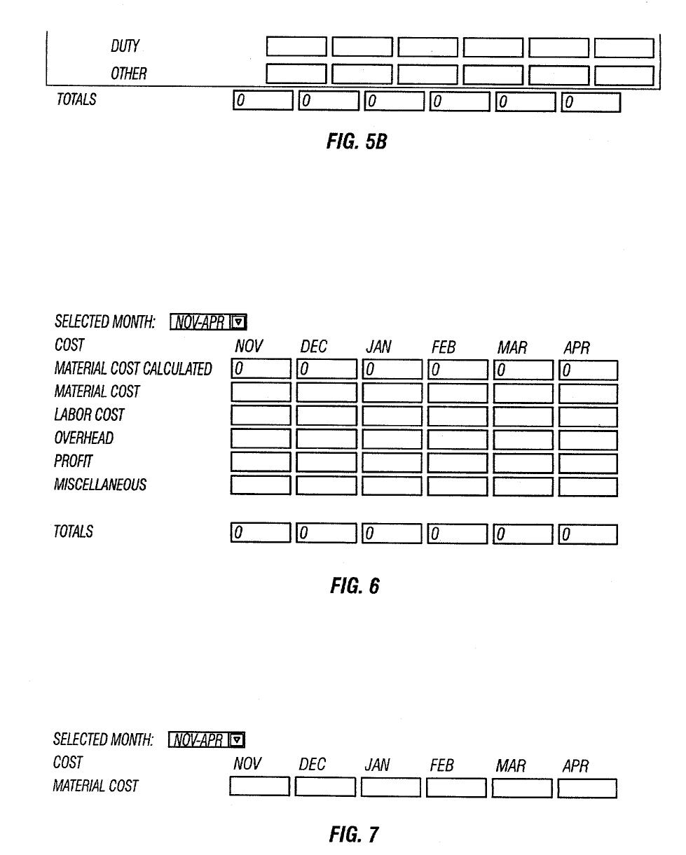

FIGS. 5A and 5B show a detailed view of a root level cost presentation, i.e., a detailed view of a purchased part at the root level. The root level cost presentation divides costs for an element into nine categories including material cost, labor cost, overhead, profit, freight, supplier logistic center (also referred to as “revolver” or “hub”), warranty, supplier absorption and miscellaneous.” In a preferred embodiment, the nine main categories are further divided into 21 additional subcategories. In most cases, material costs are a significant factor of a component cost. Risk management tool 105 allows a supplier to either enter component cost data for all components that make up the assemblies and the root or the total cost of the assembly. If a supplier does not want to provide the cost data for the components that make up the sub-assembly and root, then the supplier has the option to provide the material cost, depicted in presentation 502.

Presentation 502 (material cost) allows a user to specify a cost of an item. Presentation 503 (material cost calculated) adds the individual sub-component costs to determine the total material cost. This feature allows a user to estimate costs for a bill of materials based on known costs for certain items within the bill of materials. For any given purchased part either presentation 502 (material cost) or presentation 503 (material cost calculated) may be populated. Freight cost, service logistic center cost and warranty cost are further divided into sub-categories as shown in presentations 504, 506 and 508 in FIG. 5A. For example, freight is divided into freight cost, insurance, fuel surcharge/credit and air (exceptions). Similarly, presentation 510 allows a user to identify six months for which costs will be entered.

FIG. 6 shows a detailed view of cost of a purchased part at the sub-assembly level. Component costs for a sub-assembly are divided into the categories: material cost calculated, material cost, labor cost, overhead, profit and miscellaneous. FIG. 7 shows a detailed view of the material cost of a component. A component is the smallest unit in a bill of materials and therefore is not further divided. Hence, the material cost of a component cannot be divided further.

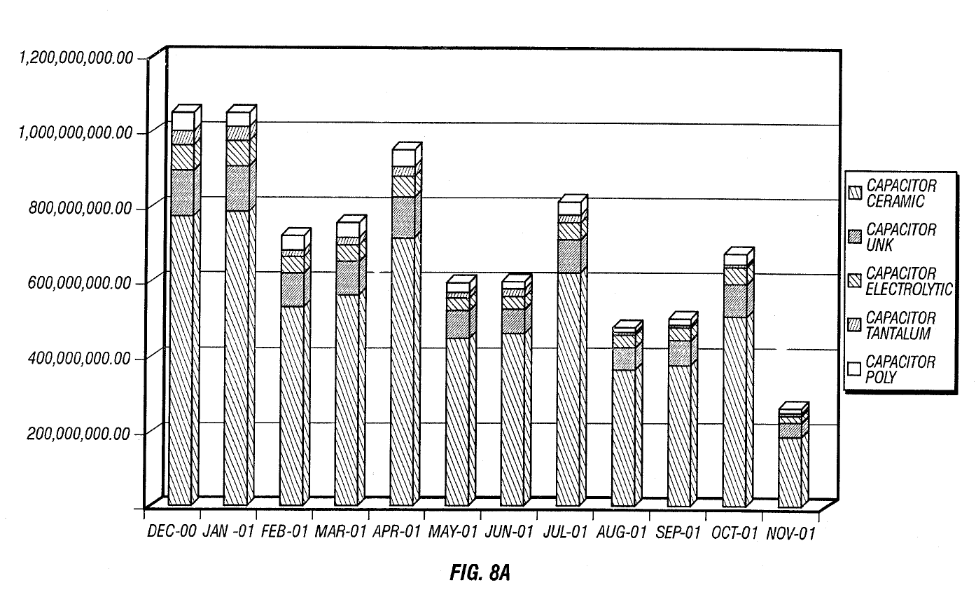

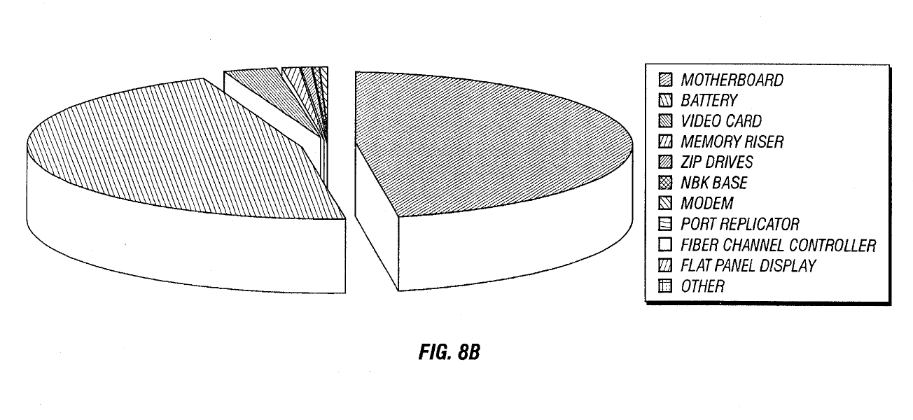

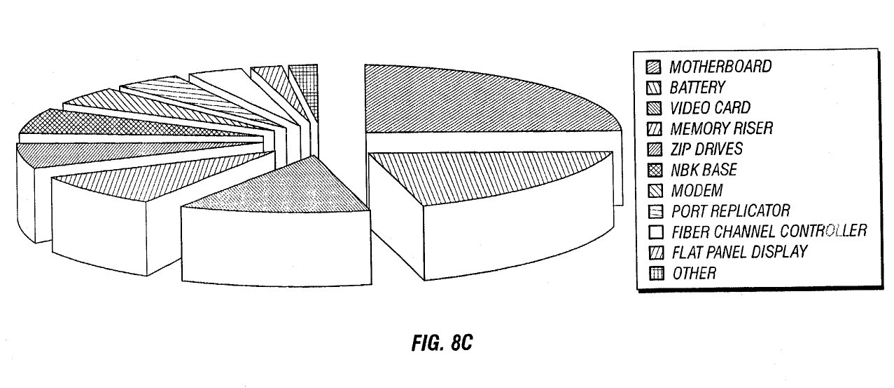

FIGS. 8A, 8B and 8C show examples of reports available from risk management tool 105. FIGS. 8A, 8B and 8C show the availability of capacitors used by a manufacturer. The use of a capacitor as an example is not limiting. FIG. 8A shows a report of the volume of the listed types of capacitors required during the time period specified. FIG. 8B shows where certain capacitors are used in an assembled computer system. FIG. 8C shows the concentration of capacitors produced by certain suppliers.

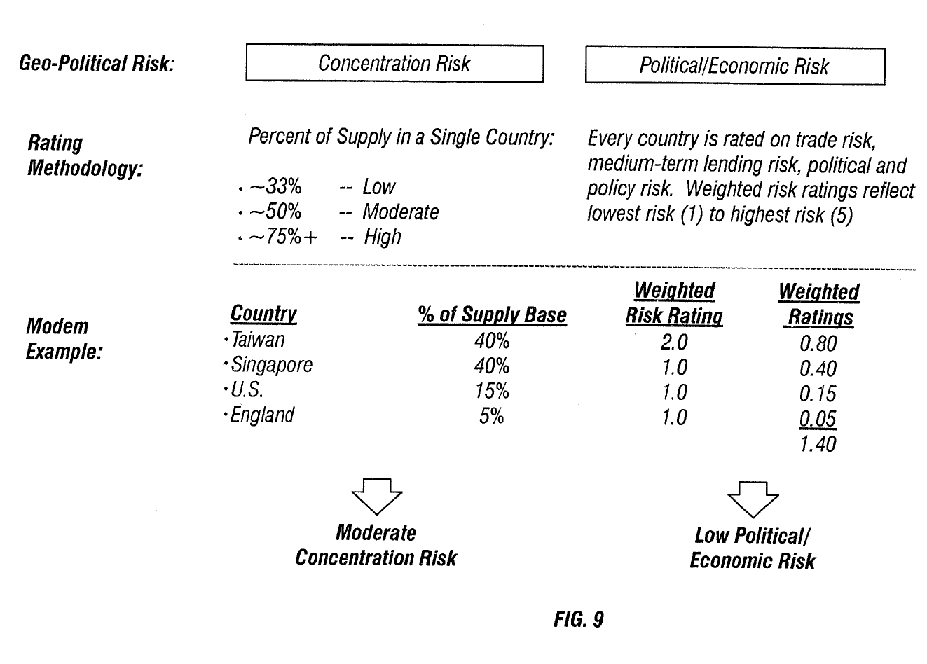

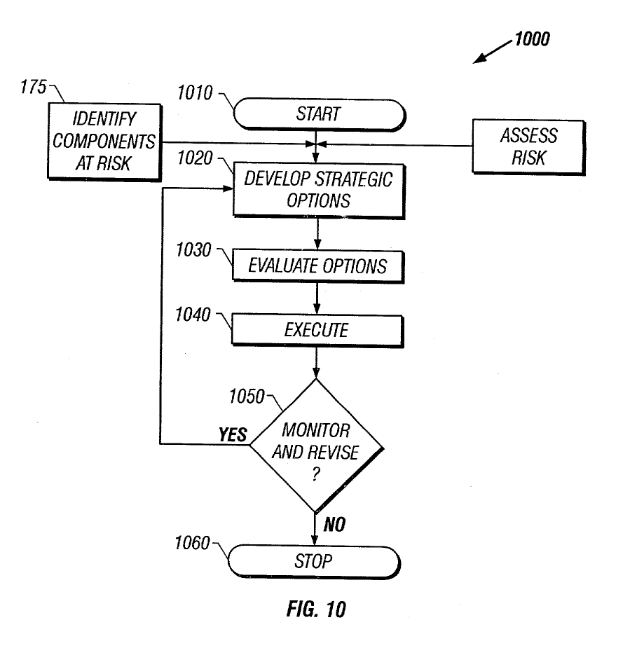

FIG. 9 shows an example of another report available from risk management tool 105. Using a modem as an example, the report presents a table reflecting the percentage of a supply base of modems received from individual countries. The report shows an example of geopolitical risk for Taiwan, Singapore, the United States and England. The report includes the weighted risk rating for each country listed. Although four countries are identified in FIG. 9, the method is not limited to these four countries and this example is not limiting. Similarly, although a modem is used as an example of a component purchased from a supplier, this example is not limiting.

Continuity of Supply Methodology

The Continuity of Supply Methodology 1000 allows a user to identify and assess risks to the continuity of supply including; capital cycle risk, innovation risk, supplier power risk and geopolitical risk. The Continuity of Supply Methodology 1000 allows a user to develop and implement a strategy to mitigate these risks and facilitates assessment of the strategies implemented. Selecting a specific strategic option can depend on potential impact of the risk.

Components at-risk are identified from module 175 (FIG. 1). Event 1020 permits a user to develop strategic options for mitigating risk to a supply chain. After a data analysis reveals a potential disruption to the continuity of supply of purchased materials the manufacturer can develop options to minimize the risk. For example if capital cycle risk is significant, the manufacturer can evaluate options to purchase manufacturing capacity or develop a preferential relationship with a supplier.

Event 1030 allows a manufacturer or user to evaluate these strategic options based on cost to implement, time to implement, impact on continuity of supply, supplier's willingness and a manufacturer's willingness. After evaluating strategic options, event 1040 executes the option selected. Event 1050 includes monitoring and revising options which were previously implemented. Event 1050 also includes a decision to develop additional options if the option implemented is not sufficiently successful.

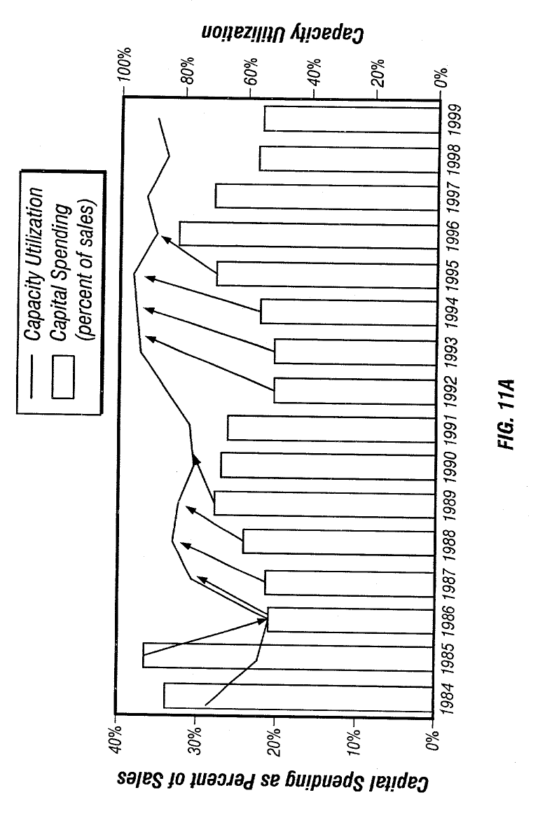

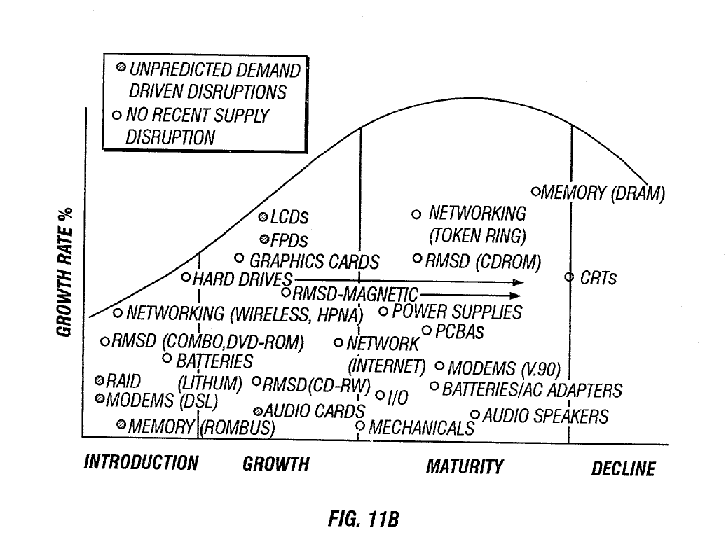

FIGS. 11A and 11B show examples of reports available based upon the Continuity of Supply Methodology 1000 . FIG. 11A shows a bar graph of capital spending as a percentage of sales for the period identified. FIG. 11B shows the growth rate (in percentage) versus the four phases in a product's life cycle, introduction, growth, maturity and decline. FIG. 11B also identifies items having unpredicted demand disruptions and items not having recent disruptions in supply.

An Example Organizational Module

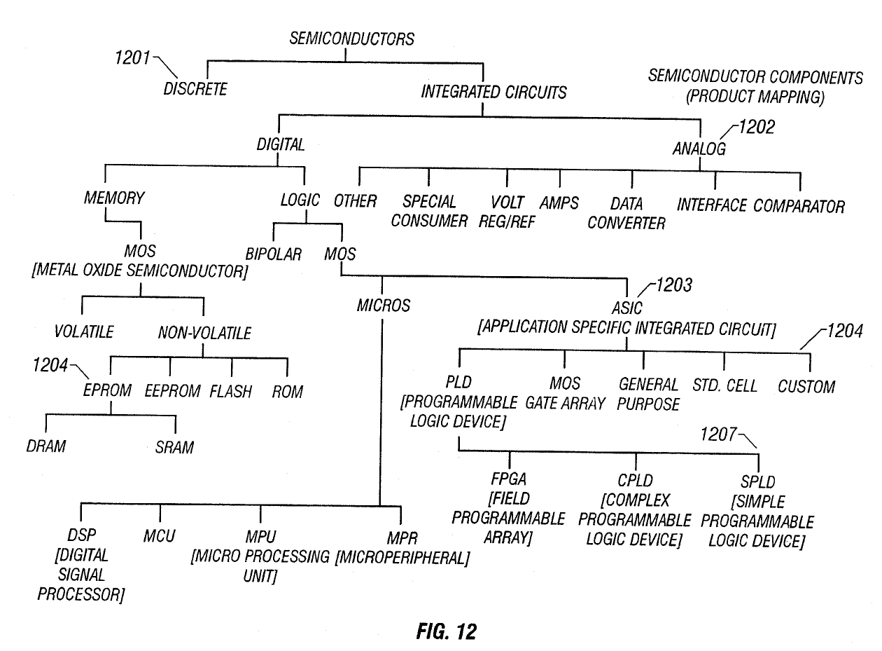

FIG. 12 shows an organization hierarchy for semiconductor components and illustrates a product mapping module of risk management tool 105. Other product mapping modules may be used to organize components of a bill of material.

A reference document (RefDoc) contains lookup information for risk management tool 105. RefDoc is an XML document that contains data that is used to classify components and sub-assemblies using properties that classify the form, fit and function of the components and sub-assemblies. Risk management tool 105 refers to RefDoc to populate the data in a structure document (Xdoc), described further below. Finally, RefDoc contains a comprehensive list of component attributes and sub-assembly attributes. For example RefDoc stores countries, suppliers and fabrication foundries. RefDoc also contains a blank template for attributes to be stored in Xdoc. An example of a document which satisfies these requirements is set forth in Table 1, below.

TABLE 1
RefDoc.xml example

<?xml version=“1.0”?>
<ATTRIBUTES>

<SUPPLIER_LIST>

<SUPPLIER>

<SUPPLIER_ID>766</SUPPLIER_ID>
<NAME>NAME123</NAME>

</SUPPLIER>

</SUPPLIER_LIST>
<FAB_LOCATIONS>

<FAB>

<FAB_ID>300</FAB_ID>
<NAME>3Com</NAME>

</FAB>

</FAB_LOCATIONS>
<COUNTRIES>

<COUNTRY>

Similarly, Xdoc stores the structure of the bill of materials and the various properties of each component. An example of a software architecture which can accomplish these functions is set forth in Table 2, below.

TABLE 2
XDoc.xml example

<COST>

<NAME>Material

Cost</NAME>

<COST_ID>1</COST_ID>

<COST_TYPE>1</COST_TYPE>

<CURRENT_COST/>
<FORECAST1_COST/>
<FORECAST2_COST/>
<FORECAST3_COST/>
<FORECAST4_COST/>
<FORECAST5_COST/>
<SUB_COSTS/>

</COST>

Refdoc and Xdoc have been written collaboratively in XML, a markup language further discussed below. By using XML, information providers can define new tag and attribute names at will, document structures can be nested to any level of complexity; and any XML document can contain an optional description of its grammar for use by applications that need to perform structural validation.

The invention is not limited to any particular software or mark-up language. For example JavaScript is used to write routines (referred to as “client side scripts”) that are routines to respond to user interaction. Similarly VB Script may also be used to write routines to respond to user interaction. JavaScript is supported by Internet Explorer and Netscape. VB Script is supported by Internet Explorer.

An Example of a Manufactured Product

The present disclosure is applicable to any manufactured good. A computer system is used as an example of a manufactured product for which the method may be practiced. Computer system 1330 includes central processing unit (CPU) 1332 connected by host bus 1334 to various components including main memory 1336, storage device controller 1338, network interface 1340, audio and video controllers 1342, and input/output devices 1344 connected via input/output (I/O) controllers 1346. Those skilled in the art will appreciate that this system encompasses all types of computer systems including, for example, mainframes, minicomputers, workstations, servers, personal computers, Internet terminals, network appliances, notebooks, palm tops, personal digital assistants, and embedded systems.

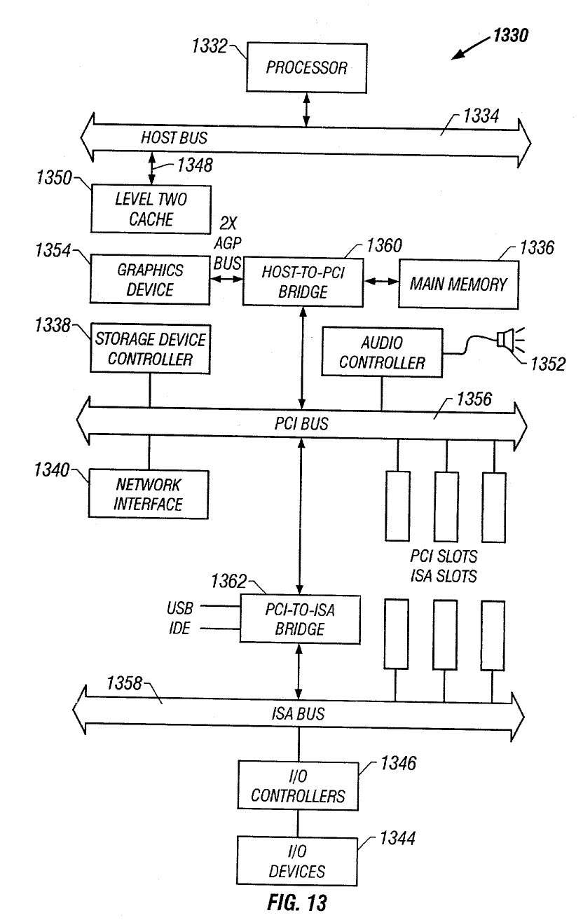

Typically computer system 1330 also includes cache memory 1350 to facilitate quicker access between processor 1332 and main memory 1336. I/O peripheral devices often include speaker systems 1352, graphics devices 1354, and other I/O devices 1344 such as display monitors, keyboards, mouse-type input devices, floppy and hard disk drives, DVD drives, CD-ROM drives, and printers. Many computer systems also include network capability, terminal devices, modems, televisions, sound devices, voice recognition devices, electronic pen devices, and mass storage devices such as tape drives. The number of devices available to add to personal computer systems continues to grow, however computer system 1330 may include fewer components than shown in FIG. 13 and described herein. The peripheral devices usually communicate with processor 1332 over one or more buses 1334, 1356, 1358, with the buses communicating with each other through the use of one or more bridges 1360, 1362.

An Example Operating Environment

As discussed previously, features of the invention may communicate information electronically. Risk management tool 105 communicates electronically with suppliers 140 and with individuals who monitor activity of the tool to increase compliance 165. The invention may communicate information electronically across a medium such as the Internet but may also exchange information across any other operable medium. As stated previously, the Internet is used as an example and use of the example should not be taken to be limiting.

An example of a typical Internet connection is shown in FIG. 14. A user that wishes to access the Internet typically has a computer workstation, such as computer system 1330 as shown in FIG. 13. Workstation 1412 executes an application program known as a web browser 1414. Workstation 1412 establishes a communication link 1416 with web server 1418 such as a dial-up wired connection with a modem, a direct link such as a T1 or ISDN line, a wireless connection through a cellular or satellite network. When the user enters a request for information by entering commands in web browser 1414, work station 1412 sends a request for information, such as a search for documents pertaining to a specified topic, or a specific web page to web server 1418. Each web server 1418, 1420, 1422, 1424 on the Internet has a known address which the user must supply to the web browser 1414 in order to connect to the appropriate web server 1418, 1420, 1422, or 1424. If the information is available on the user's web server 1018, a central link such as backbone 1426 allows web servers 1418, 1420, 1422, 1424 to communicate with one another to supply the requested information. Web server 1418 services requests for the information and receives information from (or transmits information to) workstation 1412. In an embodiment of the invention a user may use a workstation, such as workstation 1412 to transmit information to server 1418 which stores the information.

A user at an individual PC (such as workstation 1412) that wishes to access the Internet typically does so using a software application known as a web browser. A web browser uses a standardized interface protocol, such as HyperText Transfer Protocol (HTTP), to make a connection via the Internet to other computers known as web servers, and to receive information from the web servers that is displayed on the user's display. Information displayed to the user is typically organized into pages that are constructed using a specialized language such as Hypertext Markup Language (HTML), Extensible Markup Language (XML), and Wireless Markup Language (WML), hereinafter (markup languages). Markup languages are typically based on the Standard Generalized Markup Language (SGML) that was created with the original purpose of having one standard language that could be used to share documents among all computers, regardless of hardware and operating system configurations. To this end, markup language files use a standard set of code tags embedded in their text that describes the elements of a document. The web browser interprets the code tags so that each computer having its own unique hardware and software capabilities is able to display the document while preserving the original format of the document.

Web pages are translated into the appropriate language and stored as hard-coded HTML and/or active server pages (ASP). There are a number of different web browsers available, each supporting their own extensions to markup languages such as HTML. Thus, a document written for one browser may not be interpreted as intended on another browser if it does not support the same extensions. XML was designed to meet the requirements of large-scale web content providers for industry-specific markup (i.e., encoded descriptions of a document's storage layout and logical structure), vendor-neutral data exchange, media-independent publishing, one-on-one marketing, workflow management in collaborative authoring environments.

Also, the method is not restricted to a specific software, software language or software architecture. Each of the steps of the method disclosed may be performed by a module (e.g., a software module) or a portion of a module executing on a computer system. The method may be embodied in a machine-readable and/or computer-readable medium for configuring a computer system to execute the method. Thus, the software modules may be stored within and/or transmitted to a computer system memory to configure the computer system to perform the functions of the module.

While particular embodiments of the present invention have been shown and described, it will be obvious to those skilled in the art that, based upon the teachings herein, changes and modifications may be made without departing from this invention and its broader aspects, and therefore, the appended claims are to encompass within their scope all such changes and modifications as are within the true spirit and scope of this invention. Furthermore, it is to be understood that the invention is solely defined by the appended claims.

What is claimed is:

1. A method of identifying potential risk, the risk due to potential disruptions in material supply to a manufacturing facility, the method comprising:
identifying a component for an assembled product, the component being purchased from a supplier, wherein identifying the component includes identifying the supplier and a manufacturer's part number of the component; and
storing an identity of the component.

2. A method of identifying potential risk, the risk due to potential disruptions in material supply to a manufacturing facility, the method comprising:
determining a set of components for an assembled product;
storing the set of components;
determining a set of sub-components for the set of components;
storing the set of sub-components; and
combining the set of components and the set of sub-components.

3. The method as recited in claim 2, further comprising:
storing a country of origin of the set of components.

4. The method as recited in claim 2, further comprising:
storing an indicia of the geopolitical risk associated with the country of origin of the set of components.

5. The method as recited in claim 2, further comprising:
storing an identity of a supplier of the set of components.

6. The method as recited in claim 2, further comprising:
storing an identity of an assembler of the set of components.

7. The method as recited in claim 2, further comprising:
determining a product assembled by a manufacturer, the product including the set of components.

8. The method as recited in claim 2, further comprising:
determining an end-of-life date of the set of components.

9. The method as recited in claim 8, further comprising:
identifying components at-risk from the set of components due to a capital cycle risk of the set of components.

10. The method as recited in claim 2, further comprising:
storing the identity of a fabricator of the set of components, wherein the identity of the fabricator includes the name of the foundry.

11. The method as recited in claim 2, further comprising:
determining which components from the set of components are implicated based upon an identified geopolitical risk.

12. The method as recited in claim 2, further comprising:
determining which components from the set of components are implicated based upon an identified innovation risk.

13. The method as recited in claim 2, further comprising:
determining which components from the set of components are implicated based upon an identified risk due to a supplier concentration.

14. The method as recited in claim 2, further comprising:
identifying components within a fixed period of an end-of-life date.

15. The method as recited in claim 2, further comprising:
forecasting future requirements of a component.

16. The method as recited in claim 15, further comprising:
forecasting future shortages of the components.

17. A method of determining a benchmark cost for a component across a plurality of commodities, comprising:
determining a material cost;
determining a cost of labor to assemble a component;
determining cost of labor to test a component;
determining a profit;
determining an overhead cost;
determining a freight cost;
determining a warranty cost; and
benchmarking the components across the plurality of commodities based upon the aforementioned steps.

18. The method as recited in claim 17, further comprising;
determining a cost to operate a supplier logistic hub;
adding the material cost, the cost of labor to assemble a component, the cost of labor to test a component, the profit, the overhead cost, the freight cost, the warranty cost and the cost to operate a supplier logistic hub; and
benchmarking the cost of the component.

19. The method as recited in claim 17, further comprising:
determining a supplier absorption cost;
adding the material cost, the cost of labor to assemble a component, the cost of labor to test a component, the profit, the overhead cost, the freight cost, the warranty cost and the supplier absorption cost; and
benchmarking the cost of the component.

20. The method as recited in claim 17, further comprising:
determining a miscellaneous cost;
adding the material cost, the cost of labor to assemble the component, the cost of labor to test the component, the overhead cost, the freight cost, the warranty cost and the miscellaneous cost; and
benchmarking the cost of the component.

21. A method for determining a best bill of materials, comprising:
determining a benchmark cost for the bill of materials supplied by a supplier;
determining a class of suppliers, the class of suppliers supplying equivalent bills of materials to a manufacturer; and
determining a supplier within a class of suppliers, the supplier providing a lowest cost bill of materials to the manufacturer.

22. A method for manufacturing a computer system, comprising:
determining a best bill of materials; and
assembling the computer system with a component, the component determined by the best bill of materials.

23. A method of designing a computer system, comprising:
determining a benchmark cost of a component; and
determining a best costed bill of materials for a computer system.

24. A method of assembling a computer system, comprising:
assembling a set of components, wherein a component included in the set of components is selected by determining a best costed bill of materials, wherein the best costed bill of materials is determined by a benchmark cost of the component selected.

25. A system for managing purchasing information, comprising:
a computer system, the computer system including a processor, a memory and
a database, the database comprising:
an identifier of a component; and
a part number of the component, the part number assigned to the component by a manufacturer.

26. The system as recited in claim 25, the database further comprising:
a country of origin of the component.

27. The system as recited in claim 26, the database also including an indicia of geopolitical risk of the country of origin.

28. The system as recited in claim 25, the database further comprising:
the identity of a supplier of the component, the identity of the supplier including a location of the supplier.

29. The system as recited in claim 25, the database further comprising:
a name of a foundry of the component.

30. The system as recited in claim 25, the database further comprising:
a vendor of the component.

31. The system as recited in claim 25, the database further comprising:
an end-of-life date for the component.

32. The system as recited in claim 25, further comprising:
a set of sub-components.

33. A system for managing purchasing information, the system on a computer system, the computer system including a processor and a memory, the system comprising:
a non-volatile computer readable memory, the non-volatile computer readable memory including:
instructions to determine a benchmark cost of material.

34. The system as recited in claim 33, the non-volatile computer readable memory also including:
instructions to determine a best bill of materials.

35. A method of forecasting materials requirements, comprising:
storing on a non-volatile computer readable media a set of components for an assembled product;
storing on a non-volatile computer readable media set of sub-components for the set of components;
combining the set of components and the set of sub-components;
storing on a non-volatile computer readable media the combined set of components and sub-components;
determining from suppliers the quantity of components available during a specified time period;
developing a production plan, the production plan estimating the quantity of items by be manufactured within a specified time period; and
comparing the quantity of material projected by the production plan to the quantity of components available from suppliers.

36. A method of organizing a bill of materials, comprising:
determining an attribute of component;
determining a sub-attribute grouping of the component;
determining a sub-attribute of the attribute, the sub-attribute associated with the group; and
storing in a database the attribute and sub-attribute of the component.

37. A method of comparing components, comprising:
determining an attributes of a first component;
storing in a database the attribute of the first component;
determining an attributes of a second component;
storing in a database the attribute of the second component;
comparing electronically the attribute of first component to the attribute of the second component; and
identifying the second component not equivalent to the first component if the attributes do not match.

38. The method of identifying a substitute component, comprising:
determining an attributes of a first component;
storing in a database the attribute of the first component;
determining an attributes of a second component;
storing in a database the attribute of the second component;
comparing electronically the attribute of first component to the attribute of the second component; and
identifying the second component a substitute for the first component if the attributes match.

39. A computer program product encoded on computer readable media, the computer program product comprising:
instructions, executable on a computer system, configured to store a bill of materials, the bill of materials comprising:
a first component, the first component having an attribute; and
a second component, the second component having an attribute.

40. The system as recited in claim 39, further comprising:
instructions configured to compare the attribute of the first component with the attribute of the second component.

41. The system as recited in claim 39, wherein the attribute of the first component is an end-of-life date of the first component.

42. The system as recited in claim 39, wherein the attribute of the first component is a part number, the part number assigned by a manufacturer.

43. The system as recited in claim 39, wherein the attribute of the first component is a country of origin of the first component.

44. The system as recited in claim 39, wherein the attribute of the first component is an indicia of risk of the county of origin of the first component.

45. The system as recited in claim 39, wherein the attribute of the first component is a location of a foundry of the first component.

46. The system as recited in claim 39, wherein the attribute of the first component is a vendor of the first component.
